(19) United States
(12) Patent Application Publication
(10) Pub. No.: US 2007/0039490 A1
(43) Pub. Date: Feb. 22, 2007

(54) Machine for printing on hollow bodies

(75) Inventors: Helmut Aichele, Goppingen (DE); Martin Frank, Geislingen/Steige (DE)

Correspondence Address: BROWDY AND NEIMARK, P.L.L.C.;624 NINTH STREET, NW, SUITE 300, WASHINGTON, DC, 20001-5303, US

(73) Assignee: Hinterkopf GmbH, Eislingen/Fils (DE)

(21) Appl. No.: 11/492,091

(22) Filed: Jul. 25, 2006

(30) Foreign Application Priority Data
Aug. 20, 2005 (DE) 05 018 119.7

(51) Int. Cl. B41F 17/00

(52) U.S. Cl. 101/35

(57) ABSTRACT

A machine for printing on hollow bodies such as sleeves, collapsible tubes, cans or the like, comprises receiving spindles having a horizontal axis of rotation on which receiving spindles are arranged which precede along a spindle track curve during stepped rotational movement of the spindle plate. Along this spindle track curve a plurality of combined printing and drying stations are distributed, which each possess a rotary screen printing mechanism for printing on hollow bodies mounted on the receiving spindles and a radiation dryer for drying ink applied to the hollow bodies. Within the printing and drying stations the rotary screen printing mechanism and the radiation dryer are respectively opposite one another, the latter being so designed that same may simultaneously act on the receiving spindle located at the time in the associated printing and drying station.

### BACKGROUND OF THE INVENTION

The invention relates to a machine for printing on hollow bodies such as sleeves, collapsible tubes, cans or the like, comprising:

a spindle plate able to be rotated in steps and having a horizontal axis of rotation, which spindle plate bears spindle units following each other with a clearance in succession in the direction of rotation, such spindles respectively possessing a receiving spindle aligned parallel to the axis of rotation, and able to mount the respective hollow body to be printed and which during rotation of the spindle plate describe a spindle track curve,

a plurality of printing stations distributed along the spindle track curve, which respectively possess a rotary screen printing mechanism having a tubular rotary screen aligned in parallelism to the receiving spindles, such rotary screen being adapted to make rolling engagement with the outer periphery of the hollow body positioned at the time in the respective printing station with a simultaneous application of ink,

a plurality of drying stations distributed along the spindle track curve, which respectively have a radiation dryer able to irradiate the hollow body seated at the time in the respective drying station on the respective receiving spindle for drying the previously applied ink.

### THE PRIOR ART

A machine of this type suitable for printing on hollow bodies such as sleeves, collapsible tubes, cans or the like is disclosed of the European patent publication EP 1 468 827 A1. The machine comprises a spindle plate driven in rotation which is fitted with a plurality of receiving spindles distributed in the direction of rotation, over which the hollow bodies to be printed are slipped. During operation the spindle plate performs a stepped movement, the receiving spindles, together with the hollow bodies seated on them, being positioned in successively placed printing stations and drying stations. Each printing station comprises a rotary screen printing mechanism, by which the direct application of ink takes place on the hollow body placed at the time in the respective printing station. The drying stations respectively comprise a radiation dryer, which permits speedy drying. The printing stations and the drying stations are arranged in an alternating fashion, a drying station following each printing station in the direction of rotation. In order to have a space-saving arrangement the rotary screen printing mechanisms are placed radially outside the spindle track curve and the radiation dryers radially within it.

If a screen printed image is to be produced extending over the full periphery of the hollow body, an extremely exact control of the rotary screen printing mechanisms is required in order to ensure as far as possible a gap-free and exact transition between the end and beginning of the printed image. In order to prevent gaps in the printed image it has so far hardly been possible to avoid a slight overlap at the start and end of the printed image, something leading to ugly printing effects.

PATENT ABSTRACTS OF JAPAN VOL. 017, No. 433 (M-1461), 11.8.1993 (1993-08-11) and the Japanese patent publication 05 096704 A (to MISTSUBISHI MATERIALS CORP), 20.4.1993 (1993-04-20) disclose a machine for printing on hollow bodies using a plurality of offset printing stations. Each printing station is placed radially opposite a drying station. During the processing of a hollow body there is firstly the printing operation and then the drying operation.

### SHORT SUMMARY OF THE INVENTION

One object of the invention consequently is to provide a machine of the type initially mentioned which permits precise and high quality printing.

In order to achieve these and/or other objects appearing from the present specification, claims and drawings, in the present invention one respective printing station and a drying station are arranged in pairs as a combined printing and drying station, in which respectively one rotary screen printing mechanism and one radiation dryer, lying on opposite sides of the spindle track curve, are opposite to each other in the radial direction of the spindle plate, the rotary screen printing mechanism and the radiation dryer being so designed that same simultaneously act on that hollow body which is seated at the time on the receiving spindle momentarily located in the associated printing and drying station and rotates simultaneously with same.

In the combined printing and drying stations it is accordingly possible for printing and drying to take place simultaneously on different positions of its periphery. The printing ink applied by the rotary screen printing mechanism accordingly does not return, after one rotation of the hollow body (owing to the drying operation then occurring), in the wet condition but rather in the already dry condition to the rotary screen printing mechanism. Even if therefore the start and the end of an applied printed image should overlap slightly, this will hardly impair the printing quality, because the start of the printed image will already be dried and the colors of the ink application can not be mixed. All in all the processing time for the individual hollow bodies is shorter than in the prior art.

The ink layer application will preferably be controlled by a moving doctor, which is able to be brought into a position effective at the inner face of the rotary screen or in an ineffective position removed form it. Since for this switching of position a certain minimum time is necessary, in many cases it will not be possible to avoid the rotary screen coming into contact with an already printed area of the hollow body. In a conventional set-up this might mean smearing of the ink. However since the ink is already dried, such impairments are not possible in the present case.

A further effect of the invention is that the length of the periphery of the spindle plate necessary for printing and drying the hollow body is relatively short.

Further advantageous developments of the invention are defined in the claims.

Preferably on the one hand all rotary screen printing mechanisms and on the other hand all radiation dryers are on respectively the same side of the spindle track curve. Because the rotary screen printing mechanisms generally have larger dimensions than the radiation dryers it is hence advantageous to arrange the rotary screen printing mechanisms radially outside the spindle track curve and the radiation dryer radially within it.

The distance between respectively following combined printing and drying stations preferably is equal to twice rotational step of the spindle plate. Since owing to the dimensions of the rotary screen printing mechanisms as a rule a certain distance must be left between successively following printing and drying stations and not gone below, it is possible in this fashion both to have a close distribution of the receiving spindles, which takes into account the normally smaller distance apart of the sleeve bodies supplied to the spindle plate.

However nevertheless it would in principle be possible as well to adapt the rotary stepping of the spindle plate to the distance apart of two following printing and drying stations.

The receiving spindles are driven in rotation at least while dwelling in a printing and drying station. Such a rotary drive can however also be outside the printing and drying stations, at least in phases.

Since within the printing and drying stations the rotary screen printing mechanisms and the radiation dryers are essentially opposite to one another, there is, even owing to the intermediately placed receiving spindle, an automatic shielding of the rotary screen printing mechanisms from the drying radiation of the radiation dryer located in the same station. Owing to such shielding it is possible to exclude the possibility of the rotary screen being irradiated and the ink thereon being dried. In order to achieve a particularly high efficiency of shielding it is however possible for separate shielding means to be present in addition, which completely prevent the above mentioned effect of stray radiation or at least reduce it even more.

It is particularly advantageous for the shielding means to possess shielding elements which are located between respectively adjacent receiving spindles directly on the spindle plate and accordingly partake in its stepped rotary movement. Accordingly it is unnecessary to provide complex mechanisms requiring much time for their operation in order to place the shielding elements alternatingly within and without the intermediate space lying between adjacent receiving spindles.

Preferably the machine will be so operated that after the termination of the printing operation with a respective printing and drying station, while the receiving spindle is still turning, a plain drying operation takes place so that the applied print image is completely dried. Should one rotation of the hollow body not suffice to produce the desired effect of drying, the receiving spindle may, after the completion of drying be optionally rotated farther with the radiation dryer still working, until the desired degree of drying is achieved.

Owing to the radiation technology employed the drying operation takes place extremely speedily in all cases. Preferably the radiation dryers are in the form of UV dryers or IR dryers and emit ultraviolet radiation (UV radiation) or infrared radiation (IR radiation) as radiation effective for drying.

Further advantageous developments and convenient forms of the invention will be understood from the following detailed descriptive disclosure of one embodiment thereof in conjunction with the accompanying drawings.

### LIST OF THE SEVERAL VIEWS OF THE FIGURES

FIG. 1 diagrammatically shows a horizontal front view of a preferred design of the printing machine in accordance with the invention.

FIG. 2 is a partly sectioned plan view of the printing machine of FIG. 1 on the section line II -II, only two of the several receiving spindles arranged on the spindle plate being depicted to make the drawing more straightforward.

FIG. 3 shows the section marked as III of the printing machine, the doctor control only being illustrated in detail for one of the rotary screen printing mechanisms.

FIG. 4 shows a section on the section line IV-IV through the arrangement of FIG. 3.

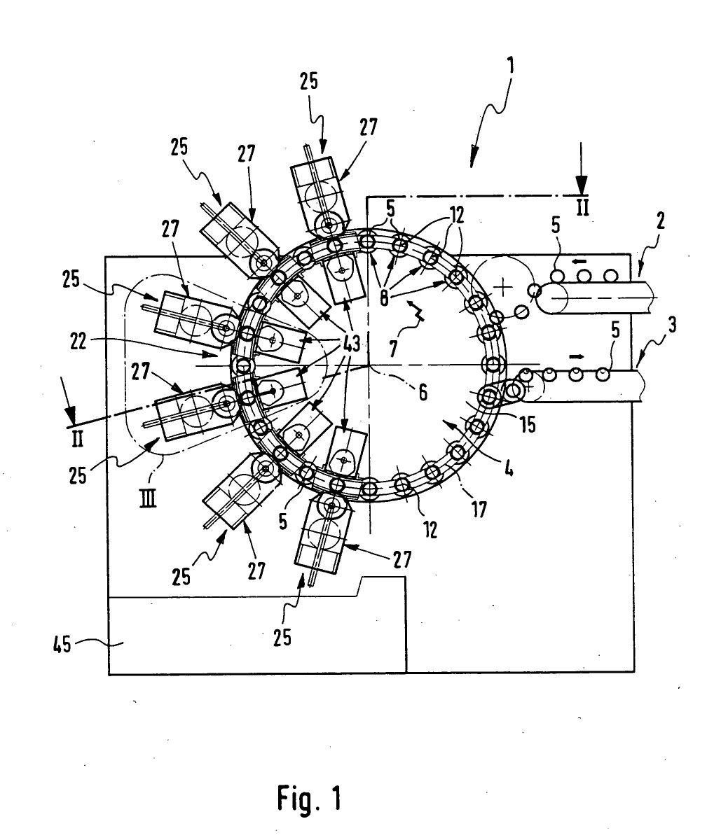

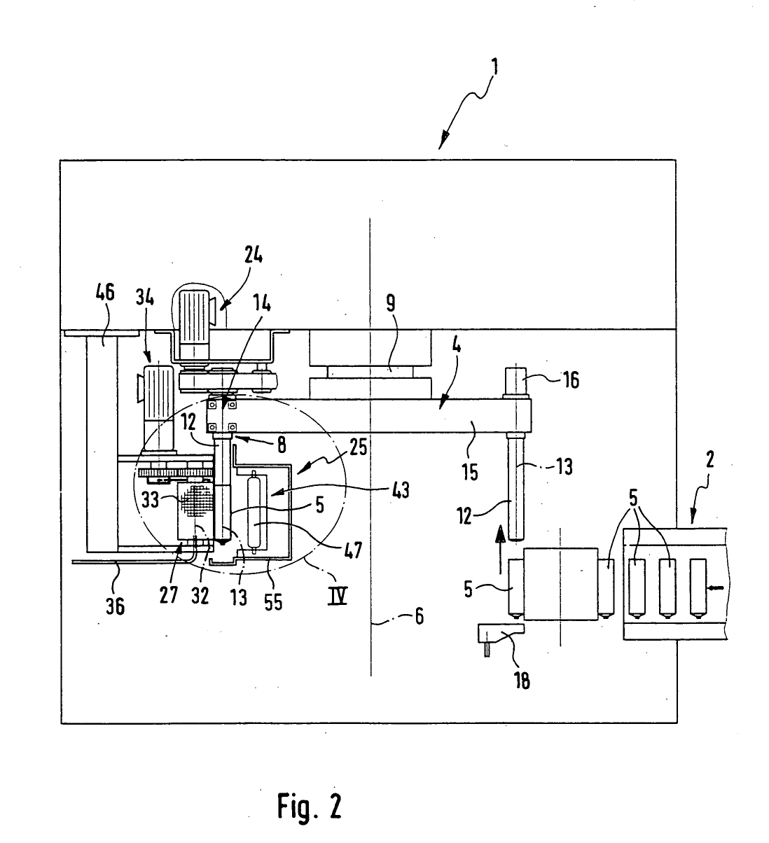

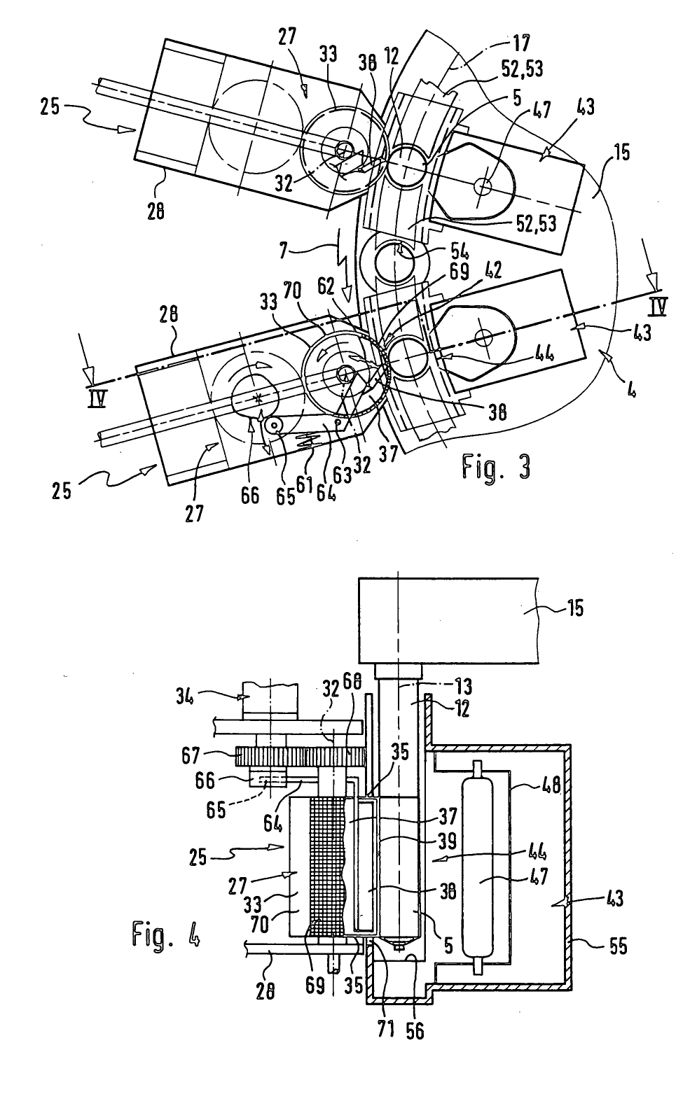

### DETAILED ACCOUNT OF. WORKING EMBODIMENT OF THE INVENTION

The printing machine generally referenced 1 as a whole comprises inter alia a supply conveying means 2 and a removal conveying means 3, which are respectively associated with the peripheral portion of a receiving spindle 4 able to be caused to rotate in steps by a drive, which is not illustrated in detail. By means of the supply conveying means 2 hollow bodies 5 to be printed can be supplied. Using the removal conveying means 3 already printed hollow bodies 5 may be taken over by the spindle plate 4 and cleared from the system.

As regards details the spindle plate 4 may be driven in steps as a rotary movement about the axis of rotation 6 with a direction of rotation 7 indicated by the jagged arrow 7. The axis 6 of rotation is horizontal in direction. The spindle plate 4 is mounted for rotation about a hub 9 on the machine frame 45.

The spindle plate 4 is provided with a plurality of spindle units 8 following each other in the direction of rotation 7 with a clearance between them, such units respectively comprising a receiving spindle 12 whose spindle axis 13 is parallel to the axis 6 of rotation.

The spindle units 8 and accordingly also the receiving spindles 12 are located in the peripheral portion of the spindle plate 4. Each spindle unit 8 has a bearing means 14, which is arranged in the vicinity of the outer edge of the disk-like plate body 15 of the spindle plate 4 and starting from the associated receiving spindle 12 projects at the front side of the plate body 15. All receiving spindles 12 are located at the front side of the plate body 15, same being arranged at equal distances apart along the periphery of the plate body 15.

On the receiving spindles 12 it is possible for hollow bodies 5 to be printed to be releaseably mounted in a torque transmitting manner. Mounting on the spindles is performed by the supply conveying means 2 possessing suitable transfer means 18. In a similar manner the removal of already printed hollow bodies 5 is performed by the removal conveying means 3.

For locking the hollow body 5 seated on a receiving spindle 12, locking means are present which are not illustrated and which take effect on the basis of a magnetic force or on the basis of vacuum. Preferably a vacuum duct opens at the front end of each receiving spindle 12, such system being connected with a source of vacuum in order to hold the slipped-on hollow body 4 by vacuum.

Each receiving spindle 12 coupled in a torque transmitting manner with a wheel-like or roller-like drive element 16, which projects at the rear side of the plate body 15.

During the stepped rotation of the spindle plate 4 the receiving spindles 12 describe a spindle track curve 17 centered on the axis 6 of rotation.

As related to the direction 7 of rotation there is, between the supply conveying means 2 and the removal conveying means 3, an ink application zone 22 extending along a part of the periphery of the spindle plate 4. In such zone the hollow bodies 5 seated on the receiving spindles 12 are printed on their outer peripheries using the ink.

Again as related to the direction 7 of rotation it is possible to have lacquer applying means, not illustrated in detail, between the ink application zone 22 and the removal conveying means 3, in which the printed hollow bodies 5 are finally coated with a protective lacquer, more particularly a transparent one.

At least during passage through the ink application zone 22 and preferably also during passage through the optional lacquering means the receiving spindles 12, including the hollow bodies 5 seated thereon, are continuously rotated about the spindle axis 13. For this purpose the printing machine 1 comprises one or more particularly stationarily arranged drive units 24 with which the drive elements 16 of the receiving spindles 12 are drivingly coupled at least during their dwell in the ink application zone 22 so that the receiving spindles 12 turn continuously during all of the printing and drying operation with the hollow bodies 5 seated on them in the same direction about the spindle axis 13.

In the ink application 22 there are several combined printing and drying stations 25 distributed along the spindle track curve 17 in which stations the functions of a printing station and a drying station are combined.

Each such printing and drying station 25 possesses a rotary screen printing mechanism 27. Each rotary screen printing mechanism 27 has a housing 28 has a tubular screen, which during its operation is driven to perform a rotary movement about its screen axis 32 and is consequently termed a rotary screen 33. For driving the rotary screen 33 each rotary screen printing mechanism 27 is provided with its own rotary drive means 34.

The rotary screens 33 are so designed that their longitudinally extending axes 32 are arranged to be parallel to the spindle axes 13. The rotary screens 33 are so placed that in relation to the spindle axes 13 they lie at the same level as that portion of the receiving spindle 12 which is able to mount a hollow body 5.

When by suitable turning into the right angular position of the spindle plate 4 one receiving spindle 12 is positioned in a printing and drying station 25, the tubular screen wall 39 of the rotary screens 33 of the associated rotary screen printing mechanism 27 may be brought into engagement with the outer periphery of the hollow body 5 seated on the respective receiving spindle 12 in order to apply ink to the hollow body 5. The ink image so produced is defined by a correspondingly perforated wall section 69 of the screen wall 39, through which the ink flows.

At the two end sides of a respective rotary screen 33 there is a terminating wall 35 so that a screen inner space 37 is defined which is able to be filled with printing ink. A doctor 38 arranged in the interior space 37 of the screen extends along the inner face of the circular tubular screen wall 39 in the ink application portion 42 facing the spindle track curve 17 and may cause ink to be squeezed through the screen perforations during rotation of the rotary screen 33 and applied to the outer periphery of the hollow body 5 positioned in the respective printing station 25, with which hollow body the rotary screen 33 makes rolling contact.

The doctor 38 extends in the screen's inner space 37 parallel to the screen axis 32 and is able to be adjusted as indicated by the double arrow 62 athwart the screen axis 32. In the working embodiment adjustment takes place as part of a pivoting motion because the doctor 38 is pivotally mounted for swiveling about a pivot axis 63 parallel to the screen axis 32 in relation to the housing 28. The pivotal movement is caused by an actuating arm 64 fixed to the doctor 38, such arm being driven by a rotating curve path means or cam 66 for example via a guide body 65 constituted by a follower roller. The cam 66 turns with the same angular velocity as the associated rotary screen 33 and is connected in a torque transmitting manner with a drive wheel of the rotary drive means 34, such wheel meshing with a further drive wheel 68, which is connected in a torque transmitting manner with the rotary screen 33 and causes the rotary movement thereof.

The above mentioned components constitute control means responsible for causing, during rotation of the rotary screen, the doctor 38 under the control of the cam 66 to either assume a working position engaging the inner face of the circular tubular screen wall 39 or a inactive position clear of such inner face.

The diameter of the screen wall 39 is larger than the diameter of the hollow body 5 to be printed on. In the working embodiment it is twice as large. Accordingly the screen wall 39 does not have to perform a full rotation to print the hollow body 5 over its full periphery and in the working embodiment half a rotation is sufficient.

Accordingly the screen wall 39 is only perforated along a periphery section, whose length is substantially equal to the peripheral length of the hollow body (perforated wall section 69). The remaining wall section 70 is unperforated.

The movements of the doctor 38 and the rotary screen 33 are so ganged that the doctor 38 goes into the working position when the perforated wall section 69 passes through the ink application portion 42, the flexible screen wall 39 previously set at a minimum distance from the hollow body being thrust radially outward and against the outer periphery of the hollow body 5. When the perforated wall section 69 has rolled right along the hollow body 5 the doctor 38 goes into its inactive position so that the unperforated wall section 70, moving through the ink application portion 42, is shifted slightly to be radially clear of the hollow body 5 and also no further application of ink takes place.

In each printing and drying station 25 a different ink color is applied to the hollow bodies 5. In order to ensure that such inks of different colors do not mix and smudge before the renewed application of ink on a hollow body 5 the previously applied ink is dried. This is performed in any case directly in the same printing and drying station 25, in which the ink application took place as well, a particularly efficient drying effect being produced by the circumstance that a radiation dryer 43 is employed in each printing and drying station 25, such dryer directing high-energy radiation onto the hollow body 5 just located in the respective printing and drying station 25. Such radiation is preferably in the form of ultraviolet radiation (UV radiation) or infrared radiation (IR radiation) so that the radiation dryer 43 is accordingly designed in the form of a UV dryer or an IR dryer.

The receiving spindles 12 are driven in rotation at least during their dwell in the individual printing and drying stations 25 so that drying takes place over a full periphery even if the radiation zone 44 is restricted to a section of the periphery of the receiving spindle 12 or, respectively, the hollow body 5 mounted thereon.

In the individual printing and drying stations 25 the rotary screen printing mechanism 27 and the radiation dryer 43 are arranged on opposite sides of the spindle track curve 17 radially in terms of the axis 6 of turning of the spindle plate 4. The said components are opposite to one another in the radial direction of the spindle plate 4 so that a receiving spindle positioned in the respective printing and drying station 25 is flanked on diametrallly opposite sides on the one hand by a rotary screen printing mechanism 27 and on the other hand by a radiation dryer 43.

In principle it would be possible to arrange the rotary screen printing mechanisms 27 radially within the spindle track curve 17 and the radiation dryers 43 radially outside the spindle track curve 17. There is furthermore the possibility of having different orientations of the individual printing and drying stations 25 so that the rotary screen printing mechanism 27 is in one case placed radially outside and in the other case is placed radially inside with a radially oppositely placed radiation dryer 43 in each case. Owing to the width, which is as a rule larger than in the case of the radiation dryers 43, of the rotary screen printing mechanisms 27 the design indicated in the drawings is however preferred, in which all rotary screen printing mechanisms are placed radially outside the spindle track curve 17 and all radiation dryers 43 are radially within the spindle track curve 17.

The collection together of the printing and drying stations in pairs as combined printing and drying stations offers the advantage that a hollow body 5 presently arranged on the receiving spindle 12 in the respective station may be simultaneously printed on and dried during its rotation. This renders possible compact dimensions of the printing machine 1 and extremely high processing rates.

The receiving spindles 12 dwell in a printing and drying station 25 at least until all the applied ink has moved through the radiating portion of the radiation dryer 43 during the rotation. Accordingly control will preferably be such that although for some time a simultaneous application of ink and a drying operation take place (on diametrally opposite portions of the respective hollow body 5) however after termination of the drying operation the receiving spindle 5 turning thereof is continued within the printing and drying station 25 about its longitudinal axis until all the ink applied has moved past the radiation dryer 43 which is still in operation.

Preferably the radiation dryers 43 are secured to the rotary screen printing mechanisms 27 and anchored by same on the frame 45 of the printing machine 1. The rotary screen printing mechanisms 27 are for example held by beams 46 on the machine frame 45.

The radiation dryers 43 respectively comprise a radiation source 47, as for example a UV lamp or an IR lamp, which more especially is aligned parallel to the receiving spindles 12 and is so arranged that it lies at a certain distance from the longitudinal section, which is to mount a hollow body 5, of the receiving spindle 12 positioned in the printing and drying station 25. The radiation source 47 is surrounded by a reflector 48 to focus the drying radiation and to ensure that it is directed into the desired zone 44 for irradiation on the outer periphery of the hollow body 5 positioned there.

The distance, measured in the direction 7 of turning, between two successive printing and drying stations 25 is of such a size in the working embodiment that it is the same as two steps of rotation of the spindle plate 4. Nevertheless different distances apart are possible.

In order to provide for a particularly reliable prevention of impairment of the printing operation in the printing and drying station 25 owing to drying radiation in the same on adjacent stations, the printing machine is preferably provided with shielding means 52 which stop an undesired effect of stray drying radiation in the vicinity of the rotary screen printing mechanisms 27.

Preferably the shielding means 52 comprise shielding elements 53 arranged between two respectively adjacent receiving spindles 12 and borne by the spindle plates 4 themselves. In the working embodiment elongated shielding elements 53 shaped like plates are provided, which at one end are secured to the plate body 15 and which starting at the plate body 15 extend between respectively adjacent receiving spindles 12, respectively adjacent to each other in the direction 7 of turning, to the fore parallel to the receiving spindles 12, the ends of such elements 53 being free.

The shielding elements 53 preferably have a height approximately equal to the diameter of the receiving spindles 12 and preferably possess, at the longitudinal sides facing the adjacent receiving spindles 12, concave side walls 54 with a curvature approximately the same as the curvature of the receiving spindles 12.

It is in this manner that the shielding elements 53 are able to bridge over the full intermediate space, measured in the direction 7 of rotation, between adjacent receiving spindles 12. The drying radiation coming from the radiation dryer 43 is accordingly prevented from passing through this intermediate space and irradiating the oppositely placed rotary screens 33.

The length of the shielding element 53 is preferably at least the same as the length of the receiving spindles 12. Preferably the shielding elements 53 however extend somewhat beyond the receiving spindles 12.

Owing to the concave curvature of the side walls 54 the outer periphery of the receiving spindles 12 or, respectively, the hollow bodies 5 mounted thereon may be effectively shielded over a substantial portion thereof.

Each radiation dryer 43 is preferably also provided with a guard housing 55 which encircles that portion in which the radiation drying takes place. It is in this manner that a further shielding action is effected more particularly as regards the adjacent printing and drying stations 25. Slot-like passage openings 56 provided at and in the sides, facing opposite to the direction 7 of rotation, in the guard housing 55 are placed on the spindle track curve 17 and have a large enough cross section to render possible the entry and exit of the receiving spindles 12 bearing hollow bodies 5 during stepped rotation. In order to render possible passage of the rotary screen 33 the guard housing 55 furthermore possesses a preferably slot-like further opening 71 on the side radially facing the rotary screen printing mechanism 27.

1. A machine for printing on hollow bodies such as sleeves, collapsible tubes, cans or the like, comprising:
a spindle plate able to be rotated in steps and having a horizontal axis of rotation, which spindle plate bears spindle units following each other with a clearance in succession in the direction of rotation, such spindle units respectively possessing a receiving spindle aligned parallel to the axis of rotation, wherein the hollow bodies to be printed are able to be mounted on the receiving spindles and wherein the receiving spindles during rotation of the spindle plate are moved along a spindle track curve,
a plurality of printing stations distributed along the spindle track curve, which respectively possess a rotary screen printing mechanism having a tubular rotary screen aligned in parallelism to the receiving spindles, such rotary screen being adapted to make rolling engagement with the outer periphery of the hollow body positioned at the time in the respective printing station with a simultaneous application of ink,
a plurality of drying stations distributed along the spindle track curve, which respectively have a radiation dryer able to irradiate the hollow body seated at the time in the respective drying station on the respective receiving spindle for drying the previously applied ink,
wherein one respective printing station and a drying station are arranged in pairs as a combined printing and drying station, in which respectively one rotary screen printing mechanism and one radiation dryer, lying on opposite sides of the spindle track curve, are opposite to each other in the radial direction of the spindle plate, the rotary screen printing mechanism and the radiation dryer being so designed that they are able to simultaneously act on that hollow body which is seated at the time on the receiving spindle momentarily located in the associated printing and drying station.

2. The machine as set forth in claim 1, wherein all rotary screen printing mechanisms and all radiation dryers are respectively arranged radially on the same side of the spindle track curve.

3. The machine as set forth in claim 1, wherein the distance between respectively successively following printing and drying stations is equal to twice the rotational step of the spindle plate.

4. The machine as set forth in claim 1, comprising shielding means for preventing or at least restricting the passover of drying radiation produced in a printing and drying station by the radiation dryer therein on the radially opposite rotary screen printing mechanism.

5. The machine as set forth in claim 4, wherein the shielding means comprise shielding elements borne by the spindle plate and disposed between the respectively adjacent receiving spindles.

6. The machine as set forth in claim 5, wherein the shielding elements are mounted on the spindle plate so as to extend in a cantilever fashion.

7. The machine as set forth in claim 6, wherein the length of the shielding elements is equal to at least the length of the receiving spindles.

8. The machine as set forth in claim 5, wherein the shielding elements generally bridge over the full intermediate space between receiving spindles which are adjacent to each other in the direction of rotation.

9. The machine as set forth in claim 5, wherein on the longitudinal sides facing the adjacent receiving spindle the shielding elements possess a curved side wall extending some distance along the periphery of the respective receiving spindle.

10. The machine as set forth in claim 5., wherein the shielding elements are plate-like with concave side walls curved in a manner generally corresponding to the curvature of the receiving spindles.

11. The machine as set forth in claim 1, wherein each radiation dryer has a guard housing in which the radiation drying takes place and which extends into the spindle track curve, such guard housing having slot-like passage openings, directed in and contrary to the direction of turning, for the entry and exit of the receiving spindles, and said guard housing possesses a radially orientated further opening permitting passage therethrough of the associated rotary screen.

12. The machine as set forth in claim 1, wherein the radiation dryers are in the form of UV dryers or IR dryers.

13. The machine as set forth in claim 1, wherein within a respective printing and drying station after termination of the printing operation a plain drying operation may take place with the receiving spindle still rotating about its longitudinal axis.

14. The machine as set forth in claim 13, wherein in the interior of the rotary screens in each case a doctor is located able to be shifted in relation to the circular tubular screen wall, such doctor being able to be switched by control means cooperating with it selectively between a working position pressing against the inner face of the screen wall, in which it causes the application of printing ink, and an ineffective position moved clear of the inner face without the application of ink, the control means being so designed that after termination of a printing operation they hold the doctor in the ineffective position until the complete periphery of the hollow body mounted on the still rotating receiving spindle has been dried.

15. The machine as set forth in claim 14, wherein the cylindrical tubular screen wall of the rotary screen possesses at least one non-perforated wall section, the doctor being set in the ineffective position, when the unperforated wall section moves past it.

16. The machine as set forth in claim 1, wherein all rotary screen printing mechanisms are arranged radially outside the spindle track curve and all radiation dryers are arranged radially within it.

17. The machine as set forth in claim 16, wherein the distance between respectively successively following printing and drying stations is equal to twice the rotational step of the spindle plate.

18. The machine as set forth in claim 16, comprising shielding means for preventing or at least restricting the passover of drying radiation produced in a printing and drying station by the radiation dryer therein on the radially opposite rotary screen printing mechanism.

19. The machine as set forth in claim 18, wherein the shielding means comprise shielding elements borne by the spindle plate and disposed between the respectively adjacent receiving spindles.

20. The machine as set forth in claim 19, wherein the shielding elements are mounted on the spindle plate so as to extend in a cantilever fashion.

21. The machine as set forth in claim 20, wherein the length of the shielding elements is equal to at least the length of the receiving spindles.

22. The machine as set forth in claim 19, wherein the shielding elements generally bridge over the full intermediate space between receiving spindles which are adjacent to each other in the direction of rotation.

23. The machine as set forth in claim 19, wherein on the longitudinal sides facing the adjacent receiving spindle the shielding elements possess a curved side wall extending some distance along the periphery of the respective receiving spindle.

24. The machine as set forth in claim 19, wherein the shielding elements are plate-like with concave side walls curved in a manner generally corresponding to the curvature of the receiving spindles.

25. The machine as set forth in claim 16, wherein each radiation dryer has a guard housing in which the radiation drying takes place and which extends into the spindle track curve, such guard housing having slot-like passage openings, directed in and contrary to the direction of turning, for the entry and exit of the receiving spindles, and said guard housing possesses a radially orientated further opening permitting passage therethrough of the associated rotary screen.

26. The machine as set forth in claim 16, wherein the radiation dryers are in the form of UV dryers or IR dryers.

27. The machine as set forth in claim 16, wherein within a respective printing and drying station after termination of the printing operation a plain drying operation may take place with the receiving spindle still rotating about its longitudinal axis.

28. The machine as set forth in claim 27, wherein in the interior of the rotary screens in each case a doctor is located able to be shifted in relation to the circular tubular screen wall, such doctor being able to be switched by control means cooperating with it selectively between a working position pressing against the inner face of the screen wall, in which it causes the application of printing ink, and an ineffective position moved clear of the inner face without the application of ink, the control means being so designed that after termination of a printing operation they hold the doctor in the ineffective position until the complete periphery of the hollow body mounted on the still rotating receiving spindle has been dried.

29. The machine as set forth in claim 28, wherein the circular tubular screen wall of the rotary screen possesses at least one non-perforated wall section, the doctor being set in the ineffective position when the unperforated wall section moves past it.
